(19) United States
(12) Patent Application Publication
(10) Pub. No.: US 2010/0032506 A1
(43) Pub. Date: Feb. 11, 2010

(54) ROLLER MILL

(76) Inventor: Norbert Patzelt, Beckum (DE)

Correspondence Address: GIFFORD, KRASS, SPRINKLE,ANDERSON & CITKOWSKI, P.C, PO BOX 7021, TROY, MI, 48007-7021, US

(21) Appl. No.: 12/446,845

(22) PCT Filed: Nov. 16, 2007
(86) PCT No.: PCT/EP2007/062450

§ 371 Date: Apr. 23, 2009

(30) Foreign Application Priority Data
Nov. 20, 2006 (DE) 10 2006 054 598.2

(51) Int. Cl. B02C 4/30

(52) U.S. Cl. 241/27

(57) ABSTRACT

The roller mill according to the invention has two rotatably supported, counter-rotating rollers which together form a roller gap. There is provided in each of the two rollers at least a first and a second region which have different diameters so that the roller mill has at least a portion having a smaller roller gap and at least a portion having a larger roller gap.

The invention relates to a roller mill having two rotatably supported, counter-rotating rollers which together form a roller gap and a method and a milling installation for comminuting milling material with such a roller mill.

If such a roller mill is used to comminute a material bed, the maximum feed grain size is substantially limited by the geometry of the rollers. Currently used roller diameters of 2.4 m produce a maximum grain size range of from 50 to 70 mm. However, the feed material has a grain size of more than 200 mm in parts. Therefore, it is necessary to supply the feed material to a preliminary comminution operation in primary crushers, secondary crushers and tertiary crushers.

Therefore, the problem addressed by the invention is to reduce the complexity for the preliminary comminution operation.

This problem is solved according to the invention by the features of claims 1, 4 and 10.

The roller mill according to the invention has two rotatably supported, counter-rotating rollers which together form a roller gap. In each of the two rollers, there is provided at least a first and a second region which have different diameters so that the roller mill has at least a portion having a smaller roller gap and at least a portion having a larger roller gap.

With such a roller mill, it is possible to carry out a preliminary comminution operation in the portion having the larger roller gap and a material bed comminution operation in the portion having the smaller roller gap. In this manner, at least a portion of the preliminary comminution operation and the material bed comminution operation can be carried out in one unit. The costs for the comminution of the milling material are thereby reduced both in the context of the installation costs and in the context of the ongoing operating costs.

The method according to the invention for comminuting milling material uses the above-described roller mill, with at least a portion of the milling material which is to be comminuted being supplied first to the portion of the roller mill having the larger roller gap and subsequently at least partially to the portion of the roller mill having the smaller roller gap.

The mill installation according to the invention further makes provision for, in addition to the above-described roller mill, at least one sieve which has a first and a second outlet, with one of the two outlets being connected to the portion of the roller mill having the larger roller gap.

The dependent claims relate to other configurations of the invention.

According to a first configuration of the invention, the width of the portion having the larger roller gap is between 20% and 40% of the width of the portion having the smaller roller gap. The larger roller gap is further from one to three times as large as the smaller roller gap.

According to a preferred configuration of the method for comminuting milling material, an individual grain comminution operation is carried out in the portion of the roller mill having the larger roller gap and a material bed comminution operation is carried out in the portion of the roller mill having the smaller roller gap.

It can further be provided that the milling material to be comminuted is first sieved and subsequently the coarse material from the sieving operation is supplied to the portion of the roller mill having the larger roller gap and the fine material from the sieving operation is supplied to the portion of the roller mill having the smaller roller gap. The comminuted milling material of the portion of the roller mill having the larger roller gap is supplied either to the sieving operation again or to the portion of the roller mill having the smaller roller gap.

The milling material to be comminuted in the portion of the roller mill having the smaller roller gap can either be sieved or conveyed away as finished material.

In another construction, the milling material to be comminuted is first sieved, with the fine material from the sieving operation being supplied to the portion of the roller mill having the larger roller gap and the coarse material from the sieving operation being supplied to an additional crusher.

According to another configuration, the comminuted material of the portion of the roller mill having the smaller roller gap is sieved, with the coarse material from the sieving operation being conveyed away from the portion of the roller mill having the smaller roller gap and the fine material from the sieving operation being conveyed away as finished material.

Further advantages and configurations of the invention will be explained in greater detail below with reference to the description of a number of embodiments and the drawings, in which:

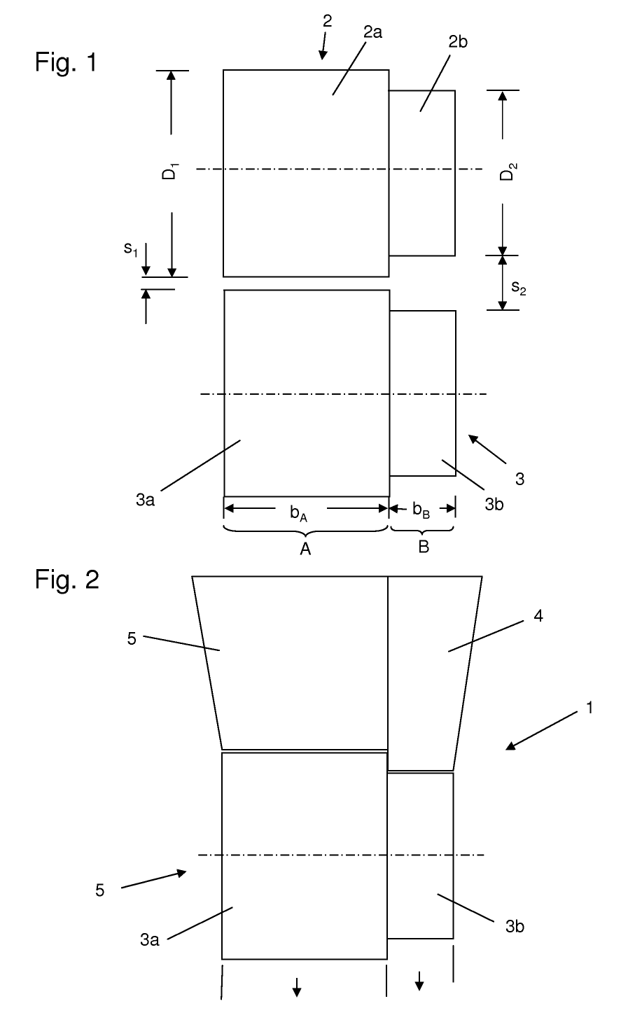

FIG. 1 is a schematic top view of the rollers of the roller mill according to a first embodiment,

FIG. 2 is a schematic side view of the roller mill,

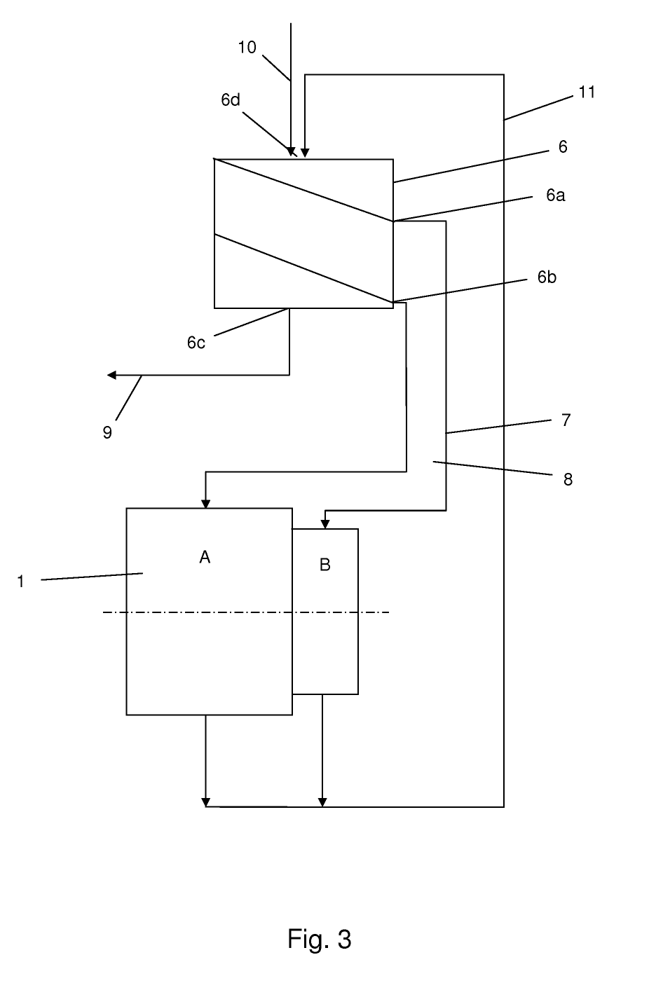

FIG. 3 is a flow circuit diagram of a mill installation according to a first embodiment,

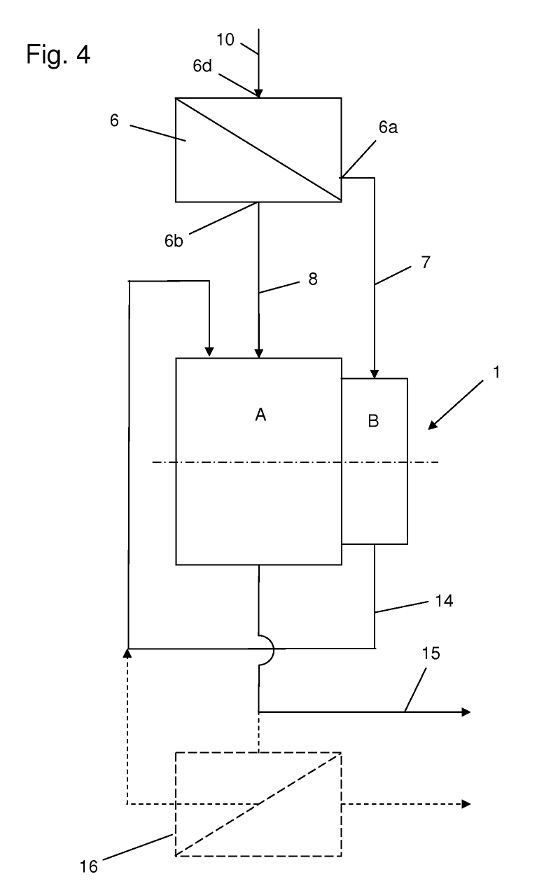

FIG. 4 is a flow circuit diagram of a mill installation according to a second embodiment,

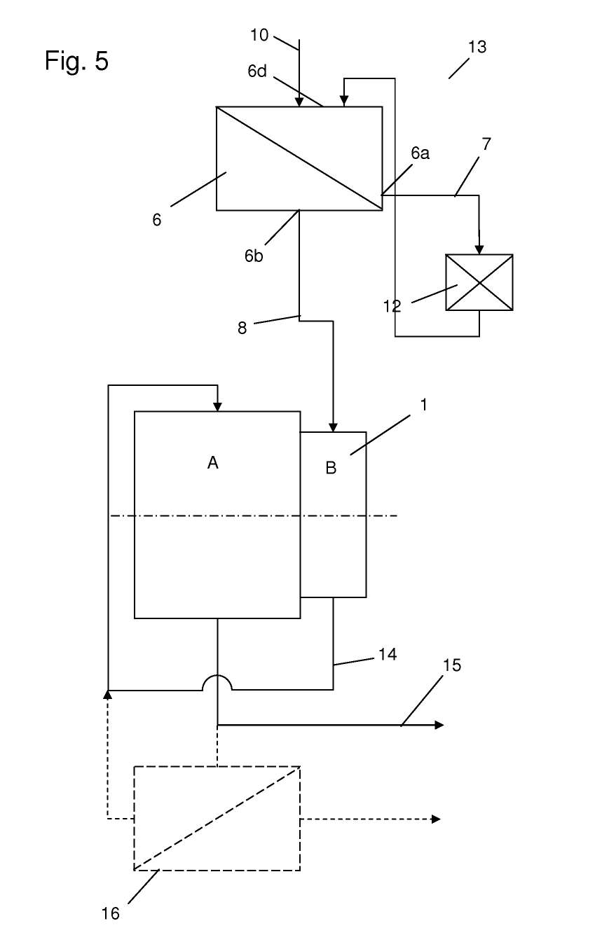

FIG. 5 is a flow circuit diagram of a mill installation according to a third embodiment and

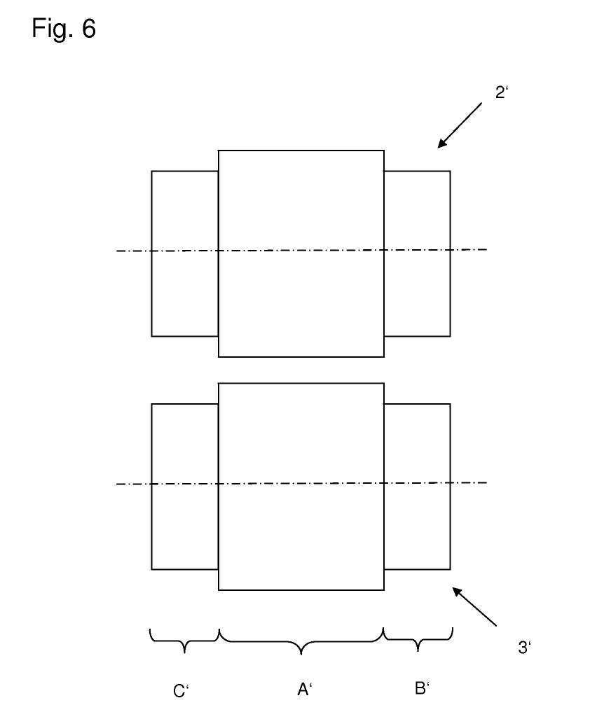

FIG. 6 is a schematic top view of the rollers of the roller mill according to a second embodiment.

The roller mill 1 which is illustrated in FIG. 1 and FIG. 2 has two rotatably supported, counter-rotating rollers 2, 3 which together form a roller gap. The two rollers 2, 3 each have a first and a second region 2a, 2b and 3a, 3b, respectively, which have different diameters D₁, D₂ so that the roller mill has a portion A having a smaller roller gap s₁ and a portion B having a larger roller gap s₂. The width b_{B} of the portion B having the larger roller gap s₂ is between 20% and 40% of the width b_{A} of the portion A having the smaller roller gap s₁. The larger roller gap s₂ is further from one to three times as large as the smaller roller gap s₁.

With such dimensions for the diameters of the two rollers, it is possible, for example, for a feed grain size of from 140 to 225 mm to be comminuted in a roller gap s₂ of 45 mm. The width of the two portions is particularly determined by the mass flows.

By means of the above-described roller mill, the number of crushers necessary for the preliminary comminution operation can be reduced. With corresponding dimensions, it is even possible to completely dispense with any preliminary crushers. Not only is the mechanical complexity significantly reduced thereby, but it is also possible to achieve substantial savings in terms of energy consumption.

With a roller mill of this type, it is possible to carry out individual grain comminution in the portion B of the roller mill having the larger roller gap and material bed comminution in the portion A of the roller mill having the smaller roller gap. Naturally, this requires that the roller mill have two mutually separate supply chutes 4, 5.

Each of the two rollers 2, 3 is supported in a manner generally known. In this instance, one roller is generally constructed as a fixed roller and the other as an idle roller. A corresponding drive and a pressing device are further provided.

FIG. 3 shows a first embodiment of a milling installation having the above-described roller mill 1, upstream of which there is connected a sieve device 6 which has a first discharge opening 6a for coarse material 7, a second discharge opening 6b and a third discharge opening 6c for finished material. The sieve device 6 further provides an inlet opening 6d for fresh material 10 and recirculated material 11.

The coarse material 7 from the sieving operation is supplied to the portion B having the larger roller gap, in which individual grain comminution is carried out. The fine material 8 from the sieving operation reaches the portion A having the smaller roller gap and is subjected to a material bed comminution operation at that location. The output material of the two portions A, B of the roller mill 1 is supplied to the sieve 6 again via the inlet opening 6d in the form of recirculated material 11.

In the second embodiment shown in FIG. 4, the sieve device 6 has only a first discharge opening 6a for coarse material 7 and a second discharge opening 6b for fine material 8. Only fresh material 10 is supplied via the inlet opening 6d. The coarse material 7 is supplied to the portion B of the roller mill having the larger roller gap and the fine material 8 is supplied to the portion A of the roller mill having the smaller roller gap. Individual grain comminution is again carried out in the portion B and material bed comminution is again carried out in the portion A. The milling material 14 comminuted in the portion B is supplied to the portion A having the smaller roller gap. The comminuted milling material 15 of the portion A of the roller mill having the smaller roller gap is either discharged as finished material 15 or supplied to a sieve 16 whose coarse material is directed to the portion A of the roller mill 1 and whose fine material is discharged as finished material.

In the event that the roller gap of the portion B of the roller mill 1 is not large enough for the fresh material, it is possible to modify the milling installation in accordance with the embodiment illustrated in FIG. 5. The sieve 6 has in this instance only a first discharge opening 6a for the coarse material 7 and a second discharge opening 6b for the fine material 8. The coarse material 7 is supplied to a crusher 12 whose discharge 13 is supplied to the sieve device 6 together with fresh material 10 via the inlet opening 6d. The fine material 8 from the sieve device 6 discharged via the second discharge opening 6b is supplied to the portion B having the larger roller gap. At that location, individual grain comminution is again carried out. The comminuted milling material 14 of the portion B is subsequently supplied to the portion A of the roller mill having the smaller roller gap and, at that location, is subjected to comminution of the material bed.

The comminuted milling material 15 of the portion A of the roller mill having the smaller roller gap is either supplied to a sieve 16 (illustrated with a broken line) or discharged as finished material 15. If the material is supplied to the sieve 16, the coarse material thereof is again supplied to the portion A of the roller mill having the smaller roller gap and the fine material thereof is conveyed away as finished material.

In the context of the invention, other circuits are also naturally conceivable and can be obtained in particular by combining the above-described circuits.

In place of the rollers shown in FIG. 1, it is also possible to use rollers 2′, 3′, as are illustrated by way of example in FIG. 6, in the constructions according to FIG. 2 to FIG. 5. In this instance, the rollers have more than two, that is, in particular three, portions A′, B′, C′. A portion A′ having a smaller roller gap and two portions B′, C′ having a larger roller gap are provided. The portions B′ and C′ can have roller gaps of identical or different sizes. They are particularly suitable as individual grain comminution steps which can be operated optionally in a parallel or sequential manner.

1-12. (canceled)

13. Method for comminuting milling material having a roller mill having two rotatably supported, counter-rotating rollers which together form a roller gap, with there being provided in each of the two rollers at least a first and a second region which have different diameters so that the roller mill has at least a portion having a smaller roller gap and at least a portion having a larger roller gap , with at least a portion of the milling material to be comminuted first being supplied to the portion of the roller mill having the larger roller gap and subsequently being supplied at least partially to the portion of the roller mill having the smaller roller gap, characterized in that individual grain comminution is carried out in the portion of the roller mill having the larger roller gap and material bed comminution is carried out in the portion of the roller mill having the smaller roller gap.

14. Method according to claim 1, characterized in that the milling material to be comminuted is first sieved and subsequently the coarse material from the sieving operation is supplied to the portion of the roller mill having the larger roller gap and the fine material from the sieving operation is supplied to the portion of the roller mill having the smaller roller gap, and the comminuted milling material of the portion of the roller mill having the larger roller gap is either supplied to the sieving operation again or to the portion of the roller mill having the smaller roller gap.

15. Method according to claim 2, characterized in that the comminuted milling material of the portion of the roller mill having the smaller roller gap is either sieved or is conveyed away as finished material .

16. Method according to claim 1, characterized in that the milling material to be comminuted is first sieved, with the fine material from the sieving operation being supplied to the portion of the roller mill having the larger roller gap and the coarse material from the sieving operation being supplied to an additional crusher.

17. Method according to one or more of claims 1, characterized in that the comminuted material of the portion of the roller mill having the smaller roller gap is sieved, with the coarse material from the sieving operation again being conveyed away from the portion of the roller mill having the smaller roller gap and the fine material from the sieving operation being conveyed away as finished material.
